(19) United States
(12) Patent Application Publication
(10) Pub. No.: US 2011/0252747 A1
(43) Pub. Date: Oct. 20, 2011

(54) Wrapping Material For Use With An Automated Packing Machine And Methods Of Manufacture And Use

(75) Inventors: Guangda Shi, Woodbury, MN (US); Chris E. Worthington, St. Paul, MN (US); Andrew J. Thoen, Harris, MN (US); Bradley J. Budde, Shakopee, MN (US); David W. Baumann, Eagan, MN (US)

(73) Assignee: CONWED PLASTICS LLC, Minneapolis, MN (US)

(21) Appl. No.: 13/086,955

(22) Filed: Apr. 14, 2011

Related U.S. Application Data
(60) Provisional application No. 61/342,428, filed on Apr. 14, 2010.

(51) Int. Cl. B65B 11/00; B32B 37/02; B65D 75/00

(52) U.S. Cl. 53/461; 229/87.01; 156/163

(57) ABSTRACT

In at least one embodiment, a wrapping material for use in covering an article on an automated packing machine includes an interconnected network of a plurality of machine-direction strands being integrally joined to a plurality of cross-direction strands to form a netting. A first film segment is situated overlapping and bonded to the netting to form a first machine-direction seal. A second film segment being spaced apart from the first film segment is situated overlapping and bonded to the netting to form a second machine-direction seal. The first or the second seal has a wave height maximum, crest-to-trough, of less than 0.25 inches. The wrapping material is capable of use without jamming the automated packing machine and without rupturing the first or second seal and processed about an article.

### CROSS-REFERENCE TO RELATED APPLICATIONS

This application claims priority to U.S. provisional Application No. 61/342,428, filed Apr. 14, 2010, which is incorporated herein by reference.

### TECHNICAL FIELD

This application relates to a wrapping material for use with an automated packing machine and methods for manufacture and use thereof.

### BACKGROUND

Automated packing machines, such as form, fill and seal packaging equipment, including flow wrap packaging machines, whether it is vertical or horizontal flow wrap packaging machines, typically use plastic film as the packaging material. But, there are many instances where perishable items, such as produce, are being packaged in this type of equipment. Plastic wrapping is not an especially good material for these types of instances, since the perishable items will last longer if they have access to air flow. In these instances, plastic wrapping has been provided with slits or openings. Such a configuration is undesirable for several reasons. First of all, such a configuration provides only a relatively small amount of ventilation. Second, increasing the area of the openings rapidly degrades the tensile strength of the package. Typically, the packaging tensile strength degrades noticeably when the area of slitting or opening of the plastic wrapping exceeds about 4 area %.

### SUMMARY

In at least one embodiment, a wrapping material for use in covering an article on an automated packing machine includes an interconnected network forming a netting. The netting includes a plurality of machine-direction strands being integrally joined to a plurality of cross-direction strands. The netting has an outwardly-facing flat side. Wrapping material also includes a first film segment situated overlapping and bonded to the netting to form a first machine-direction seal. The wrapping material also includes a second film segment spaced apart from the first film segment and situated overlapping and bonded to the netting to form a second machine-direction seal. The first seal or the second seal has a wave height maximum, crest-to-trough, of less than 0.25 inches. This wrapping material is capable of use without jamming the horizontal flow wrapping machine and without suffering rupture of the first or second seal when processed about an article.

In another embodiment, a wrapping material for use in covering an article in an automated packing machine includes an interconnected network of a plurality of machine-direction strands integrally joined to a plurality of cross-direction strands. The wrapping material also includes a first and a second film both having longitudinal axes and being situated overlapping and bonded to the netting. The netting comprises a surface area of the material ranging from 5 area % to 45 area % of the material.

In another embodiment, a method for forming a wrapping material for use in covering an article on an automated packing machine includes the steps of providing a tensioned netting including a plurality of machine-direction strands integrally joined to a plurality of cross-direction strands. A first film segment is disposed in a first overlapping relationship with the netting forming a first overlap area. A second film segment, spaced apart from the first film segment, is situated in an overlapping relationship with the netting forming a second overlap area. The netting is bonded to the first film segment forming a first film-net seal in the first overlap area. The netting is also bonded to the second film segment forming a second film-net seal in the second overlap area. The first film segment is separated from the second film segment and, when bonded, forms a tensioned film-netting-film composite. The tensioned film-netting-film composite is then cooled. The tension is released from the tensioned film-netting-film composite during the cooling step to form the wrapping material. The step of releasing the tension is done at such a rate that the first overlap area and the second overlap area have a maximum wave height of 0.25 inches when the tension is released to form the wrapping material.

### BRIEF DESCRIPTION OF THE DRAWINGS

FIG. 1 schematically illustrates a produce package using a wrapping material according to a least one embodiment;

FIG. 2 schematically illustrates a wrapping material according to at least one embodiment;

FIG. 3A illustrates a fragmentary cross-section view of FIG. 2 along 3-3 axis according to at least one embodiment;

FIG. 3B illustrates a fragmentary cross-section view similar to that of FIG. 2 along a 3-3 axis according to another embodiment;

FIG. 4A schematically illustrates a method of sealing according to a least one embodiment;

FIG. 4B schematically illustrates a method of sealing according to another embodiment;

FIGS. 5A-B is a fragmentary top view of a film-netting-film composite in two conditions according to at least one embodiment;

FIGS. 5C-D is a fragmentary top view of a film-netting-film composite in two conditions according to another embodiment;

FIG. 6A illustrates a fragmentary cross-section view along axis 6-6 of FIG. 1 of a wrapping material according to at least one embodiment;

FIG. 6B illustrates a fragmentary cross-section view similar to the view along axis 6-6 of FIG. 1 of a wrapping material according to another embodiment; and

FIG. 7 illustrates a method for manufacturing a wrapping material according to at least one embodiment.

### DETAILED DESCRIPTION

Reference will now be made in detail to presently preferred compositions, embodiments and methods of the present invention, which constitute the best modes of practicing the invention presently known to the inventors. The figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any claims and/or as a representative basis for teaching one skilled in the art to variously employ the present invention.

Except in examples, or where otherwise expressly indicated, all numerical quantities in this description used to indicate amounts of material or dimensions are to be understood as modified by the word “about” in describing the broadest scope of the invention. Practice within the numerical limits stated is generally preferred. Also, unless expressly stated to the contrary: the description of a group or class of materials as suitable or preferred for a given purpose in connection with the invention implies that mixtures of any two or more the members of the group or class are equally suitable for preferred; the first definition of an acronym or other abbreviation applies to all subsequent uses herein of the same abbreviation and applies mutatis mutandis to normal grammatical variations of the initially defined abbreviation; and, unless expressly stated to the contrary measurement of a property is determined by the same technique as previously or later referenced for the same property. Also, unless expressly stated to the contrary, percentage, “parts of,” and ratio values are by weight, and the term “polymer” includes “oligomer,” “copolymer,” “terpolymer,” “pre-polymer,” and the like.

Known current flow wrap film packaging provides ventilation for fresh produce and other items by using perforated films with relatively little ventilation. Adding one or more lanes of netting to the film greatly increases ventilation, extending the life and increasing the quality of produce.

Flow wrapping equipment is widely used in various industries, but does not have a strong presence in fresh produce packaging or other segments where high breathability is required. This invention increases the options for automated packing, especially for more delicate produce like tomatoes and some tree fruits, as the produce can be handled and packed automatically, but much more gently than with other automated packing equipment. It also allows the option of a tray, which adds protection to delicate produce.

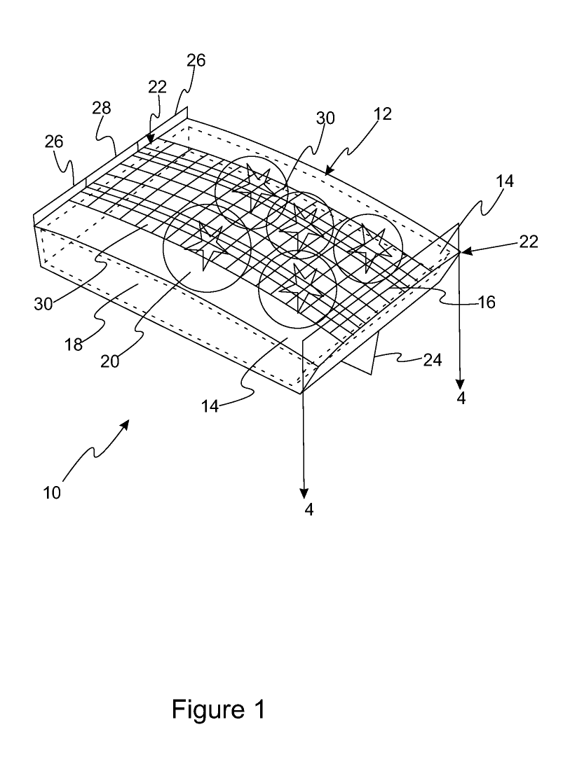

Turning now to FIG. 1, a produce package 10 using a wrapping material 12 in a wrapped state according to a least one embodiment is schematically illustrated. Wrapping material 12 is a composite and includes a plurality of film segments 14 with a netting 16 therebetween. Wrapping material 12 envelops a tray 18 containing produce 20. The wrapping material has been applied by an automated packing machine, such as a horizontal wrapping machine (not shown), and includes a plurality of end seals 22 and a sealing fin 24. End seal 22 includes a plurality of film-net-film seals 26 and at least one film-net seal 28.

Wrapping material 12 also includes a plurality of overlap areas 30 between netting 16 and film segments 14.

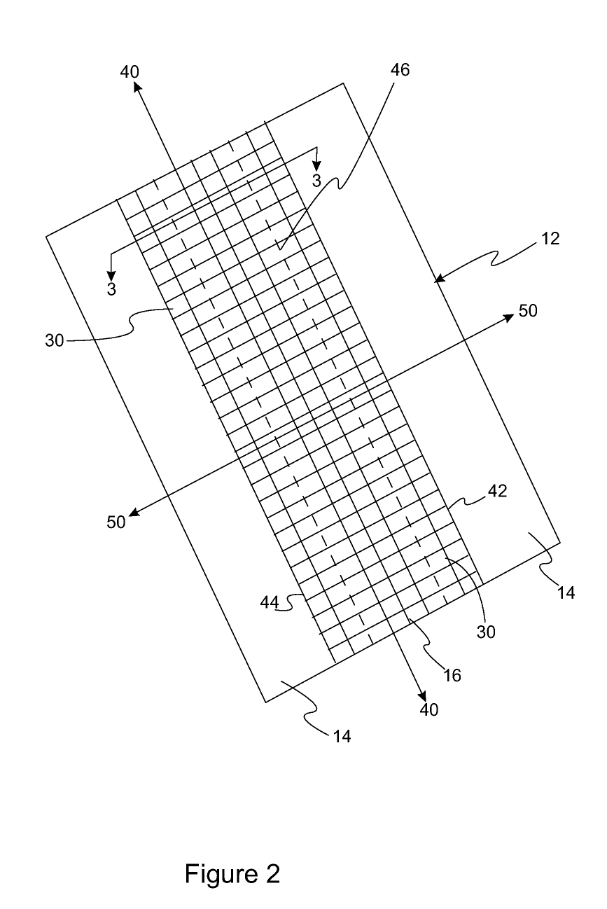

Turning now to FIG. 2, wrapping material 12 is schematically illustrated in an unwrapped state according to at least one embodiment. Wrapping material 12 is typically in a rectangular shape having a machine-direction axis 40. In general, the machine-direction axis 40 is oriented in the machine-direction of extruded netting 16. Film segments 14 are typically a rectangular shape having a longitudinal axis parallel to machine-direction axis 40. In one particular embodiment, the composite comprises a 3 inch to 6 inch lane of netting 16. Netting 16 is heat sealed or otherwise adhered to two 3-6 inch lanes of film segments 14 having polyolefin composition, one on either side. However, it should be understood that any suitable sizes and shapes of film segments 14 and netting 16 could be used. The seals between the lanes of material can be lap seals and form a relatively flat web. The result is that the wrapping material that can be used in flow wrap packaging, with the film strips generally forming the sides and back of the resulting package and the netting forming the top. In at least one embodiment, the film strips heat seal to themselves, typically using the fin seal 24, to form the package closure on the back/bottom of the package.

Extruded netting 16 has a first machine-direction periphery 42 parallel to the machine-direction axis 40 and a second machine-direction periphery 44 opposed to and spaced apart from first machine-direction periphery 42.

Film segment 14 has a periphery 46. To form the seals between the lanes, periphery 46 overlaps first machine-direction periphery 42 forming overlap area 30. Overlap area 30 ranges in width from 0.1 inches to 0.75 inches in at least one embodiment. Overlap area 30 ranges in width from 0.15 inches to 0.6 inches in another embodiment, especially with square aperture netting experiencing relatively little change in width of the netting due to necking down relative to diamond aperture netting when the netting 16 is placed under tension during forming the seal.

Wrapping material 12 includes a cross-direction axis 50 transverse to machine-direction axis 40 and in the plane of wrapping material 12.

In at least one embodiment, the netting comprises a surface area of the wrapping material 12 ranging from 5 area % to 45 area % of the wrapping material. In another embodiment, the netting comprises a surface area of the wrapping material 12 ranging from 15 area % to 35 area % of the wrapping material.

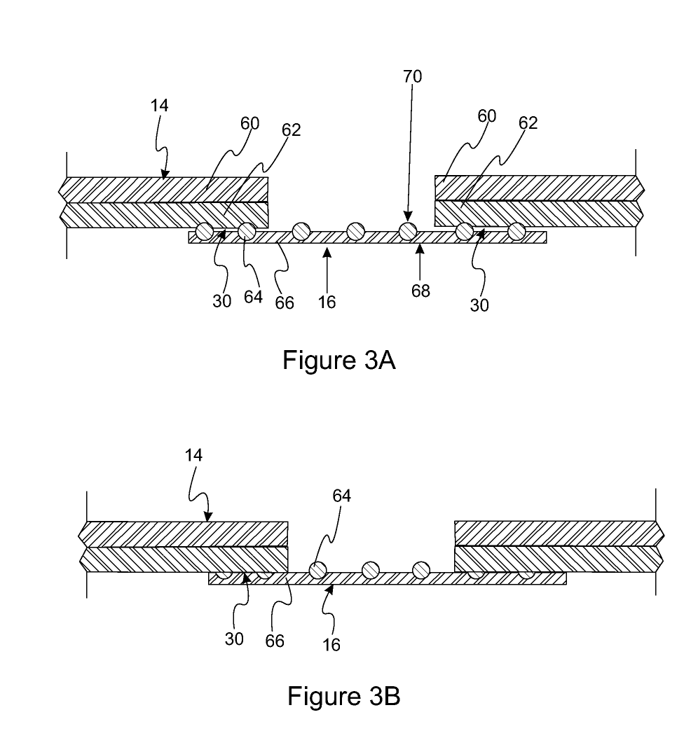

Turning now to FIG. 3A, a fragmentary cross-section view of FIG. 2 along 3-3 section is illustrated according to at least one embodiment. Film segment 14 includes two layers. A first layer 60 provides support for a second layer 62. Portions of second layer 62 are bonded to netting 16 in overlap area 30. It should be understood that film segment 14, in certain embodiments, is only one layer. In other embodiments, film segment 14 has more than two layers.

Netting 16 includes machine-direction strands 64 and cross-direction strands 66 being integrally joined to define a network. According to one technology, an exit passage of an extrusion die includes reciprocating strikers and raised and spaced lands for forming integrally joined strands such as strands 64 and 66. For instance, U.S. Pat. Nos. 4,190,692, 4,656,075 and 4,755,247 as well as U.S. Patent Application Number 2007/0056899 each provide such a die and methods of use. These patents are herein incorporated by reference in their entirety.

Netting 16 may be of many different network shapes, including extruded diamond, extruded square, oriented square netting, twill, etc. Netting aperture size may be varied to control the amount of ventilation and the package appearance. In at least one other embodiment, the netting aperture size where strands are spaced apart may range from 0.025 inches to 1 inch. In yet another embodiment, the network aperture size ranges from 0.2 inches to 0.5 inches.

It should be understood that in addition to network aperture size, netting 16 may have machine-direction strands 64 having a different composition from cross-direction strands 66. In certain embodiments, modifying the composition of machine-direction strands 69 and/or cross-direction strands influences a directional stiffness a ratio of machine-direction to cross-direction breakload balance, and a stretchiness of the netting 16. Netting 16 has been found to be useful when able to adapt to conformability in at least one direction.

Netting 16 has an outwardly-facing flat side 68 and an outwardly-facing non-flat side 70 spaced apart from and obverse to flat side 68. The non-flat side 70 arises because machine-direction strands 64 have an average center of gravity relatively higher than an average center of gravity of cross-direction strands 66 when referenced to the flat side 68. In typical use in a horizontal wrapping machine, flat side 68 of netting 16 is adjacent to the produce 20. Non-flat side 70 of netting 16 is adjacent to adhesive layer 62 of film segment 14. It should be understood, that all combinations of positioning of netting 16 relative to film segment 14 are within the scope and spirit of the embodiments. For example, netting 16 may be situated above film segment 14 relative to the produce 20. In such a positioning, the flat side 68 or the non-flat sides 70 of netting 16 may be adjacent to film segment 14. Film segment 14 may be positioned such that the adhesive layer faces away from the produce 20.

Netting 16 may comprise, in at least one embodiment, a thermoplastic composition, such as a polyolefin composition material. Non-limiting examples of polyolefin include linear low density polyethylene (LLDPE), low density polyethylene (LDPE), very low density polyethylene (VLDPE), high density polyethylene (HDPE), and polypropylene (PP). Netting 16 we also include materials having a composition including thermoplastic compositions. Non-limiting examples of the thermoplastic compositions may include nylon, polylactic acid, polyhydroxybutyrate, and PHB-co-hydroxyvalerate. It should be understood that the thermoplastic compositions may be formed of virgin or recycled products.

Film segment 14 is illustrated in FIG. 3A as being bonded substantially only to the machine-direction strands 64. In the FIG. 3B, film segment 14 is illustrated as being bonded to both the machine-direction strands 64 and the cross-direction strands 66. It is surprisingly advantageous to be able to adjust a force needed to open package 10 (i.e. the seal strength) by controlling the number and type of strands bonded to film segment 14. As described below, control of the number and types of strands bonded to film segment 14 may be controlled by the amount of pressure applied to the overlap area 30 during bonding of film segments 14 to netting 16. Seal strength may be measured according to ASTM F-88.

First layer 60 of film segment 14 may include, in at least one embodiment, a polyolefin composition material. Non-limiting examples of polyolefin include linear low density polyethylene (LLDPE), low density polyethylene (LDPE), very low density polyethylene (VLDPE), high density polyethylene (HDPE), and polypropylene (PP).

Second layer 62 of film segment 14 may include any suitable adhesive, and typically includes, in at least one embodiment, an adhesive having a lower melting point than a coextruded layer. In another embodiment, a pressure sensitive adhesive may be used on the second layer 62 of film segment 14. In another embodiment, second layer 62 may be cured for adhesion by exposure to ultraviolet light or electron irradiation. In certain embodiments, especially with produce, second layer 62 of film segment 14 is non-toxic and has an absence of odors. Non-limiting examples of a base resin for the hot melt adhesive includes ethylene vinyl acetate (EVA), copolymers of EVA, ethylene-acrylate copolymers, polyolefins including LDPE, HDPE, atactic PP, polybutene-1, amorphous polyolefin polymers and copolymers, oxidized polyethylene, polyamides, thermoplastic urethanes, styrene block copolymers, thermoplastic elastomers, silicone rubber, fluoropolymers, ethylcellulose, and polycaprolactones, especially those made with soy protein.

In another embodiment, the film is a coextruded film made of two distinct materials, as exemplarily shown in FIG. 3B. However, it should be understood that the film (or at least one of the films) could also be more or less than two materials. Also, it could be made by other several processes, such as by casting, by casting with machine-direction orientation (MDO), casting with bi-directional orientation, or by blowing. In at least one embodiment, the coextruded film comprises an adhesive layer and a strength layer, such as PE or PP. In certain embodiments, for PE materials, metallocene LLDPE's are the most typical sealant layers, with HDPE, LDPE, LLDPE or a blend of these for the strength layer, depending on the desired strength, stiffness, and thickness.

First layer 60 of the film segment 14 may, optionally, include printing on an outwardly-facing surface facing potential customers.

Second layer 62 of film segment 14 may, optionally, include additives to the base resin. In certain embodiments, additives are provided in a master batch including at least one ingredient additive and a master batch carrier composition. In certain embodiments, a base resin may be present in the amounts ranging from 50 wt. % to 99.75 wt. % of second layer 62 of film segment 14. Additives may include tackifying resins, waxes, plasticizers, antioxidants, UV stabilizers, pigments, dyes, biocide, antistatic agents, and fillers. In certain embodiments, additives may be present in the amounts ranging from 0.25 wt. % to 50 wt. % of second layer 62 of film segment 14. In another embodiment, additives may be present in the amounts ranging from 1 wt. % to 5 wt. % of second layer 62 of film segment 14.

In at least one embodiment, film segment 14 has a thickness ranging from 0.00075 to 0.003 inches. In another embodiment, film segment 14 has a thickness ranging from 0.0008 inches to 0.002 inches. In yet another embodiment, film segment 14 has a thickness ranging from 0.0009 inches to 0.0018 inches. But, it should be understood that any suitable thickness could be used.

In at least one embodiment, netting 16 has a thickness ranging from greater than the thickness of the film segment to 0.040 inches. In another embodiment, netting 16 has a thickness ranging from 0.015 inches to 0.03 inches

In at least one embodiment, film segment 14 includes a bi-axially oriented polypropylene (BOPP) film having a thickness of 0.001 inches, such as supplied by AET films (New Castle, Del.).

Closely matching the surface energy of film segment 14 to netting 16 improves the cohesion of the bond between them. In at least one embodiment, the absolute difference in surface energy between film segment 14 and netting 16 ranges from 0 to 13 dynes/cm² when measured according to ASTM D-2578. In another embodiment, the absolute difference in surface energy between film segment 14 and netting 16 ranges from 1 to 5 dynes/cm².

It is advantageous to have the first layer 60 be well bonded to the second layer 62, and to have the second layer 62 well bonded to netting 16. In at least one embodiment, bonding of each of the pairs of layers above occurs by heat bonding. Heat bonding occurs when the pair of layers is sufficiently heated to bond together in a molten state, which may include a softened state. The melt temperature of any of the thermoplastic compositions can refer to any temperature wherein the thermoplastic composition begins to melt. It should be appreciated that a mechanical bond can be created between various thermoplastic compositions without the component materials reaching their melt temperature. Indeed, one thermoplastic composition does not necessarily need to melt to adhere to another thermoplastic composition. Instead, the temperature of thermoplastic compositions, in general, may be elevated such that the component materials reach a tackified state, so that adhesion between two thermoplastic compositions may take place. This elevated temperature may be referred to as the adhesion temperature. Advantageously, the first layer 60 of the film segment 14 and at the second layer 62 have a thermoplastic composition, in at least one embodiment, where the minimum absolute difference in adhesion temperature between the first layer 60 and the second layer ranges from 10° C. to 105° C. This allows the strength layer to provide support to the article during packaging while the adhesive performs its function forming the seal. In another embodiment, the minimum absolute difference in adhesion temperature between the first layer 60 and the second layer ranges from 30° C. to 80° C.

In at least one embodiment, a minimum absolute difference in adhesion temperature between the second layer 62 of the film segment 14 and netting 16 ranges from 10° C. to 105° C. In another embodiment, the minimum absolute difference in adhesion temperature between the second layer 62 and netting 16 ranges from 30° C. to 80° C.

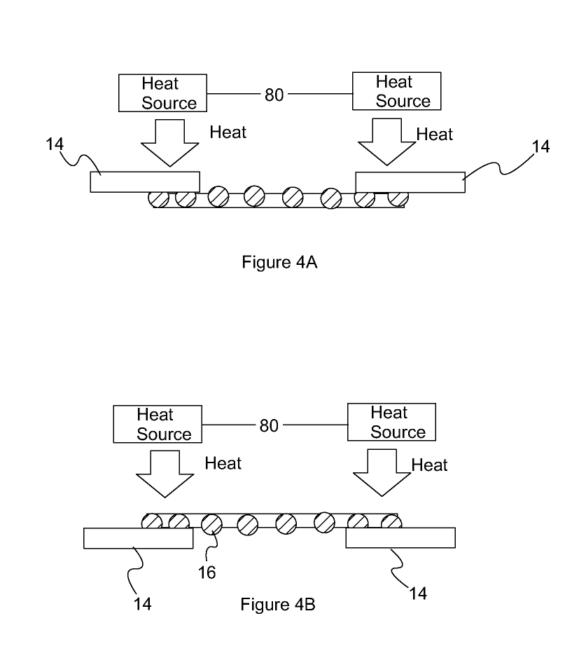

The manner in which the netting 16 is secured to the film, or vice versa, can depend upon the type of materials being used. As shown in FIG. 4A, if the netting 16 and film segment 14 is LLDPE, the film segment 14 is disposed over the netting 16 so that the film is disposed between a heat source 80 and the netting 16. In another embodiment, schematically illustrated in FIG. 4B, the netting 16 and film segment 14 material is PP, the netting 16 is disposed over the film segment 16, so that the netting 16 is disposed between the film segment 14 and the heat source 80. In at least certain embodiments, the heat is applied in a non-contact manner, such as by a stream of heated air.

In at least one embodiment of wrapping material 12, as schematically illustrated in FIGS. 4A-4B, netting 16 has a composition of LLDPE and film segment 14 has a composition of BOPP (biaxially oriented polypropylene). With respect to the PP (polypropylene film), when running BOPP film, it has been found to be difficult to drive a sufficient amount of heat through the film in order to adequately bond the film to the net without causing undesirable shrinkage or holes in the film. This is believed to be primarily due to the fact that the BOPP film is highly oriented and consequently can shrink aggressively when exposed to heat. Running the film directly against the sealing equipment roller with the net on top of the film and the heated air being applied from the netting side has been found, surprisingly, provides better seals. By better seals it is meant that the seal is such that the composite fails within the netting, rather than at the seal between the netting and the film. when tension is applied to opposite ends of the composite, as set forth in ASTM Test Method No. ASTM F88/F88M-09.

In at least one embodiment, applying heat on to the film segment 14 side is found to be generally more effective when forming seals using LLDPE film segments 14 and netting 16. In these embodiments, the LLDPE film segment is not highly oriented, as opposed to the BOPP film segment, and does not have the same tendency to shrink significantly in the presence of heat. Therefore, heat can be applied directly to the film. Moreover, the film segment 14 is generally thinner than the netting 16, thus easier to heat through in order to activate the side of the film segment 14 that is in contact with netting 16 than it would be to heat the thicker strands of netting 16. With respect to the LLDPE materials, heating through the netting 16 rather than the film segment 14 first, can cause the netting 16 to be damaged weakening netting's 16 ability to retain articles in a package and survive processing the horizontal film wrapping machine.

BOPP is known in the art to shrink significantly when heated to its adhesion temperature. Controlling the BOPP shrinkage during cooling after reaching above the BOPP adhesion temperature has been surprisingly found to be controlled by placing tension on the BOPP during cooling. To ensure an aesthetic and useable bond line on wrapping material 12, the netting 16 also is placed under tension when the overlap area 30 is heated. Release of the tension during the cooling of the bond in the overlap area 30 has been found to be surprisingly controllable such that the overlap area 30, when cooled, results in the desired aesthetic and usable bond line.

In at least one embodiment, the bond line has a wave height maximum, crest-to-trough, less than 0.25 inches. In another embodiment, the bond line has a wave height maximum ranging from 0.05 inches to 0.2 inches.

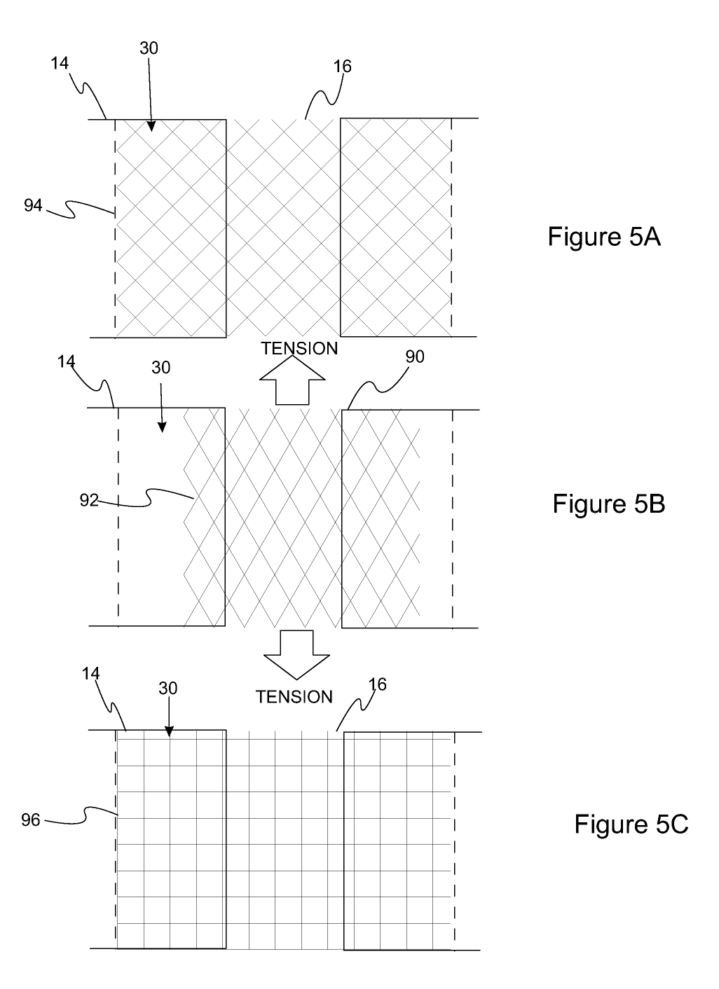

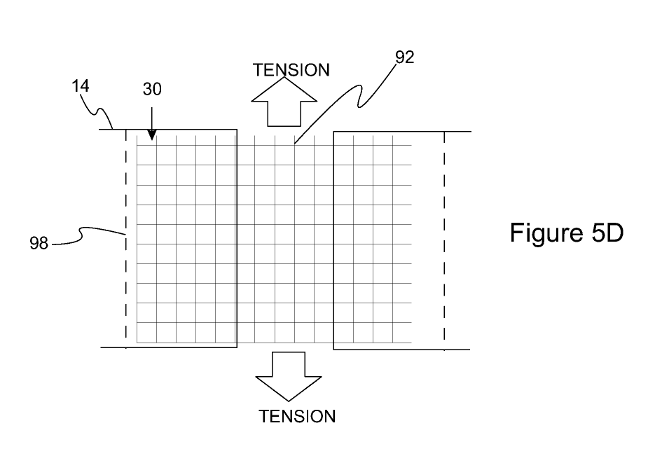

It has also been surprisingly found that the configuration of the netting 16 aperture impacts the processing. As exemplarily shown in FIGS. 5A and 5B, when netting having diamond-shaped apertures is processed, as described above, under tension, the netting necks down reducing an overlap area width 92 significantly relative to the original overlap area width 94, even threatening to leave the overlap area 30 and yield an unbonded seal area. Further, the extent of necking down is relatively inconsistent when using a diamond netting unlike a square netting. To compensate for this necking down action when under tension, the overlap area 30 when used for diamond-shaped aperture netting 16 is generally larger than the overlap area 30 used when square netting is used under tension. The effect on a width of the overlap area 96 when using square-shaped aperture netting 16 is exemplarily illustrated comparing FIGS. 5C and 5D. The width of overlap area 96 is substantially similar to a width of overlap area 98 when the square-shaped aperture netting 16 is under tension. Therefore, a narrower overlap area 30 may be used with square-shaped aperture netting 16, reducing cost by saving on material.

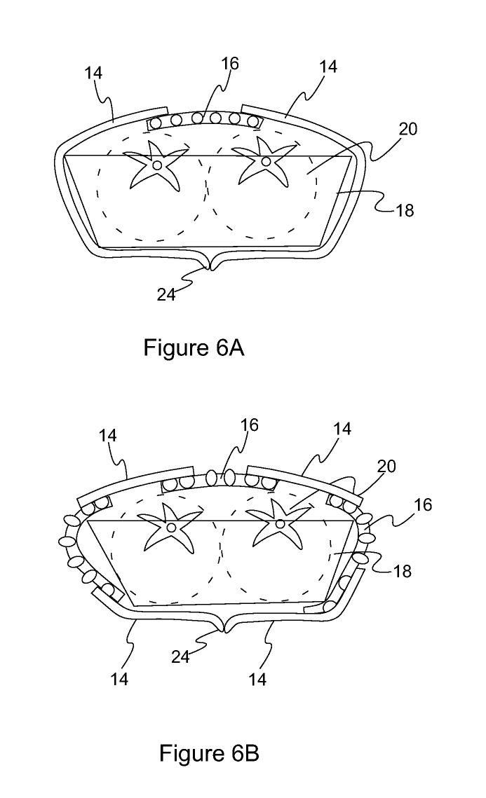

It should be understood that while wrapping material 12 is illustrated as having two film segments 14 and one netting 16, as exemplarily illustrated a cross-sectional view in FIG. 6A, the cross section being along axis 6-6 of FIG. 1. Wrapping material 12 may, in other embodiments, have a plurality of film segments 14 and a plurality of netting 16 segments as schematically illustrated in FIG. 6B. Multiple lanes of netting 16 may improve ventilation/air flow through the package. The positioning of the netting 16 segments should be such that when wrapping material 12 is folded in half along its machine-direction centerline that substantially no netting 16 segments overlap forming a netting-netting overlap. It should be understood that small or inadvertent overlap areas having netting-netting overlap may be present without exceeding the scope or spirit of the embodiments. Examples of occasions yielding such small or inadvertent overlap areas of netting-netting overlap include misregistration of wrapping material 12 on the horizontal flow wrapping machine or inadvertent twisting of wrapping material 12 during processing on the horizontal flow wrapping machine.

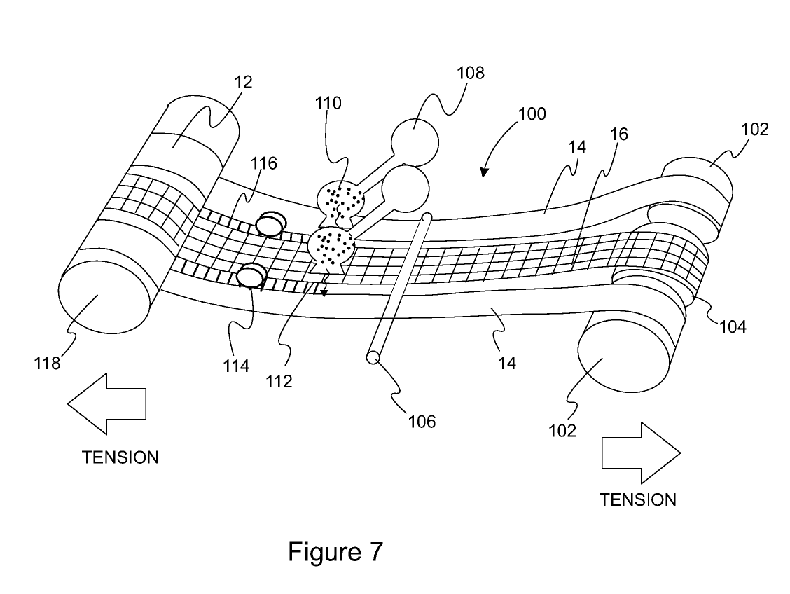

Turning to FIG. 7, a machine 100 for manufacturing wrapping material 12 composite is schematically illustrated, particularly for forming a film-netting-film composite. Feed rolls 102 pay out film segment 14. A feed roll 104 pays out netting 16. All of these feed rolls 102 and 104 are tensioned. Film segments 14 are directed by the machine to form overlap areas 30 near the idler roll 106. A heat source 108 provides heat to a blower 110 in the form of hot air. The hot air is directed to the wrapping material 12 by an air knife 112. Heat from the air knife is directed at the seam contacting the film segment 14 first to thereby soften film segment 14 and in some instances the netting, at the seam location to allow them to seal together. The air knife generally does not contact the film segment 14 and has a gap of about 0.125 inch to 0.25 inch from film segment 14. Downstream of air knife 112 is a press wheel 114 in contact with wrapping material 12. Press wheel 114 forms the machine-direction seal 116. Two press wheels 114 are shown and can provide additional pressure to the seams to insure better seals. The pressure applied to press wheels 114 is variable and may control the adhesive force that must be overcome to open the seal 116. After the film segments 14 and netting 16 are sealed to each other, the film-netting-film composite is then wound onto a roller, in particular, wrapping material 12 is taken up on a take-up reel 118 which also supplies tension. Wrapping material 12 may be shipped to a user of a horizontal flow wrapping machine, preferably for sealing produce and other perishable items.

In exemplary embodiments, the line speed of the film-netting-film composite type of wrapping material 12 for machine 100 ranges from 25 to 30 feet per minute with a temperature of the hot air gun being 600° F., or in certain embodiments ranging from 400° F. to 800° F. The temperature at the air knife exit ranges from 300° F. to 450° F. in at least one embodiment. In another embodiment, the temperature at the air knife exit ranges from 325° F. to 375° F. Thus, exemplary dwell time of wrapping material 12 beneath the hot air knife is 1 to 2 seconds. In other embodiments, the dwell time of wrapping material 12 beneath the hot air knife ranges from 0.25 seconds to 5 seconds.

In another embodiment, exemplary hot air seaming with machine 100 includes seaming PP materials. When running BOPP film, in exemplary embodiments, the line speed is generally 10 to 15 feet per minute and in other embodiments 13 feet per minute, with the temperature of the hot air gun being 700° F. and the temperature at the air knife exit ranging from 350 to 425° F. The exemplary dwell times of the structure beneath the hot air knife in view of PP film and other PP film applications is 3 to 4 seconds.

In at least one embodiment, a method of forming wrapping material 12 for use in covering an article on the horizontal flow wrapping machine includes providing a tensioned netting 16 having two parallel and spaced apart peripheral edges. The netting 16 has strands of the netting 16 are integrally joined. A first film segment 14 is disposed in an overlapping relationship with netting 16 to form the first overlap area 30. A second film segment 14 is disposed on the other peripheral edge forming a second overlap area 30. Netting 16 is bonded to the first film segment and to the second film segment to form film-netting seals situated in first and second overlap areas 30. Netting 16 with film-netting seals forms a tensioned film-netting-film composite, which is cooled. During the cooling step to form wrapping material 12, the tension is released at such a rate that the first overlap area and the second overlap area having maximum wave height, crest-to-trough, of less than 0.25 inches when the tension is fully released.

In another embodiment, the width of the tensioned netting is reduced by the method of applying tensioning. In its method of reducing the width of the tensioned netting, the first and second overlap areas are made relatively wider compared to standard overlap areas so that they can cooperate with the reduction in netting 16 width without leaving gaps where there is no sealing between tensioned netting and film segment 14.

In another embodiment, the method further includes applying pressure to press wheel 114 such that the film is bonded to both the machine-direction strands and the cross-direction strands increasing the adhesion force need to rupture the seal. In yet another embodiment, the method alternatively includes applying relatively less pressure to press wheel 114 such that the film is bonded to only the machine-direction strands, thereby, decreasing the adhesion force needed to rupture the seal.

In yet another embodiment, package 10 is formed by a method of taking wrapping material 12 and applying it to the horizontal flow wrapping machine. The netting 16 in the overlap area 30 faces the article to be wrapped. The article to be wrapped is placed on the wrapping material 12. The wrapping material 12 supports the article without rupturing the film-netting film bonds when the horizontal flow wrapping machine is wrapping the article. To finish enclosing the article in package 10, the first cross-direction periphery is sealed by a sealing bar associated with the horizontal flow wrapping machine. A second seal in the cross-direction periphery is applied to close the other end of package 10.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A wrapping material for use in covering an article on an automated packing machine, the material comprising:
an interconnected network to form a netting including a plurality of machine-direction strands being integrally joined to a plurality of cross-direction strands, the netting having an outwardly-facing flat side;
a first film segment being situated overlapping and bonded to the netting forming a first machine-direction seal; and
a second film segment being spaced apart from the first film segment, the second film segment being situated overlapping and bonded to the netting forming a second machine-direction seal, wherein the first seal or the second seal has a wave height maximum, crest-to-trough, of less than 0.25 inches forming a wrapping material capable of use without jamming the horizontal flow wrapping machine and without rupturing the first or second seal when processed about an article.

2. The material of claim 1, wherein the netting, when in use covering the article on the automated packing machine, is situated between either the first film segment or the second film segment and the article.

3. The material of claim 1, wherein the netting, when in use covering the article on a horizontal packing machine, is situated with the flat surface adjacent to the article.

4. The material of claim 1, wherein the first film, the second film, and the netting are situated, when formed on the automated packing machine, such that all seals between the first film, second film, and netting consist essentially of film-net-film seals or film-net seals.

5. The material of claim 1, wherein the first film segment has a first layer and a second layer adjacent to the first layer and to the netting, the second layer of the first film segment includes an adhesive.

6. The material of claim 1, wherein the netting has machine-direction strands and cross-direction strands situated to form a diamond netting.

7. The material of claim 1, wherein the first film segment has a first layer and a second layer adjacent to the first layer and to the netting the first layer of the first film segment includes a strength layer.

8. The material of claim 1, wherein the wave height maximum of the first or second seal ranges from 0.05 inches to 0.2 inches.

9. A wrapping material for use in covering an article on an automated packing machine, the material comprising:
an interconnected network to form a netting including a plurality of machine-direction strands being integrally joined to a plurality of cross-direction strands, the netting having an outwardly-facing flat side;
a first film segment having a longitudinal axis, the first film segment being situated overlapping and bonded to the netting; and
a second film segment having a longitudinal axis and being spaced apart from the first film segment, the second film segment being situated overlapping and bonded to the netting wherein the netting comprises a surface area of the material ranging 5 area % to 45 area % of the material.

10. The material of claim 9, further comprising an end seal situated along the first cross-direction periphery of the first film segment, the second film segment, and the netting, where in the end seal includes a first film-netting-film end seal, a second film-netting-film end seal, and a film-netting end seal disposed therebetween, when the material is used for packaging the article on the automated packing machine.

11. The material of claim 10, the overlap area ranges from 0.15 inches to 0.6 inches.

12. The material of claim 9, wherein the first film segment has a thickness ranging from 0.0075 inches to 0.002 inches.

13. The material of claim 9, wherein the netting has a thickness ranging from greater than the thickness of the first film segment to 0.0035 inches.

14. The material of claim 9, wherein the machine-direction strands have an average center of gravity relatively higher than an average center of gravity of the cross-direction strands when referenced to the flat side, the first film segment is bonded only to the machine-direction strands forming a reduced opening force package.

15. A method of forming a wrapping material for use in covering an article on an automated packing machine, the method comprising the steps of:
providing a tensioned netting including a plurality of machine-direction strands being integrally joined to a plurality of cross-direction strands, the netting having an outwardly-facing flat side;
disposing a first film segment in a first overlapping relationship with the netting forming a first overlap area;
disposing a second film segment spaced apart from the first film segment, the second film segment in a second overlapping relationship with the netting forming a second overlap area;
bonding the netting to the first film segment forming a first film-net seal in the first overlap area;
bonding the netting to the second film segment forming a second film-net seal in the second overlap area, the first film segment being separated from the second film segment forming a tensioned film-netting-film composite;
cooling the tensioned film-netting-film composite; and
releasing tension from the tensioned film-netting-film composite during the cooling step (f) to form the wrapping material, the step of releasing the tension being done at such a rate that the first overlap area and the second overlap area have a maximum wave height of 0.25 inches when the tension is released to form the wrapping material.

16. The method of claim 15, wherein the first film segment has an adhesive layer and a strength layer, the adhesive layer being situated adjacent to the netting.

17. The method of claim 16, wherein the heat is applied through the netting and directed to the adhesive layer.

18. The method of claim 15, further comprising the step of:
reducing the width of the tensioned netting by tensioning, wherein the widths of the first and second overlap areas cooperate with the reduction in width of the netting.

19. The method of claim 15, further comprising the step of:
applying pressure to the first or second overlap areas such that the film is bonded to both the machine-direction strands and the cross-direction strands increasing the adhesion force needed to rupture the seal.

20. The method of claim 15, further comprising the steps of:
applying the wrapping material to the automated packing machine with the netting in the overlap area facing the article, the wrapping material having a first cross-direction periphery parallel to the cross-direction strands and opposed to and spaced apart from a second cross-direction periphery;
providing the article on to the wrapping material;
supporting the article on the wrapping material without tearing the bond when operating the automated packing machine;
sealing the first cross-direction periphery; and
sealing the second cross-direction periphery.
